(19) United States
(12) Patent Application Publication
(10) Pub. No.: US 2026/0343040 A1
(43) Pub. Date: Oct. 29, 2026

(54) METHODS AND SYSTEMS FOR ADAPTING CONTENT PRESENTATION PARAMETERS FOR DIFFERENT USERS

(71) Applicant: Comcast Cable Communications, LLC, Philadelphia, PA (US)

(72) Inventors: Ryan MCMURRAY, Arvada, CO (US); Jonathan KIRKOVICH, Parker, CO (US); Freddy ALAS, Parker, CO (US)

(21) Appl. No.: 19/186,956

(22) Filed: Apr. 23, 2025

(51) Int. Cl. H04N 21/41

(52) U.S. Cl. CPC H04N 21/4131

(57) ABSTRACT

Methods, devices, and systems for scaling of playback environments are described herein. According to the present disclosure, a playback system may monitor environmental settings, such as luminance or chrominance settings, of a location which the playback of content occurs. The system may determine minimum and maximum environmental setting values over the period of time. When the playback system receives content and control environmental setting values as output for the content (or section of the content), the playback system may adjust the control environmental output according to the measured environmental setting of the location. The playback system may thus normalize the environmental setting output for content playback, which may provide for a more consistent environmental setting output across various locations and playback systems.

### BACKGROUND

A playback device for playing back content may be located in an environment unique to the playback device. For example, the playback device may be located at a particular position, in a particular room of a premises, having particular lighting, windows, furniture, and the like, which may each impact the conditions in which the content is displayed. Additionally, content providers may generate content with desired playback conditions in mind. However, the unique location and configuration for the playback device may affect these desired playback conditions, which may cause playback of the content in one location to differ from playback of the content in another location. These and other shortcomings are addressed by the present disclosure.

### SUMMARY

Methods, devices, and systems for the scaling of playback environments are described herein. A computing device, such as a gateway of a premises, may receive content. The content may include instructions for an optimal environmental condition, such as an optimal lighting value in the room of the playback device. The computing device may also retrieve information related to the lighting value of the room where the computing device is located. For example, the room may include devices capable of measuring the light of the room over a period of time, and the computing device may collect this information. Based on the lighting value of the room and the optimal lighting value, the computing device may generate a modified lighting value. The modified lighting value may provide for a more accurate representation of the optimal lighting conditions provided by the content provider, and according to the unique characteristics of the location where the content is to be played back.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

### BRIEF DESCRIPTION OF THE DRAWINGS

These and other features, aspects, and advantages of the present disclosure will become better understood with regard to the following description, claims, and drawings. The present disclosure is presented by way of example, and not limited by, the accompanying drawings in which like numerals indicate similar elements.

FIG. 1 shows an example communication network.

FIG. 2 shows an example content playback environment.

FIG. 3 shows an example content playback environment.

FIG. 4 shows an example content playback environment.

FIG. 5 shows example environmental parameters for content playback.

FIG. 6 shows an example computing device.

FIG. 7 shows an example method.

FIG. 8 shows an example method.

FIG. 9 shows an example method

### DETAILED DESCRIPTION OF ILLUSTRATIVE EMBODIMENTS

Methods, devices, and systems for adjusting playback environmental settings are described herein. A computing device, such as a gateway of a premises, may receive content and instructions for environmental settings during playback of the content. For example, the content may include desired light settings for the room in which the content is played back in. For example, there may be scenes in the content that occur at night, or a dark room. The desired light settings may instruct the playback system to lower the light values of the playback room during these scenes, which may cause the user to feel as if he or she is in the scene.

However, the desired light settings may be determined, or are optimal for, a particular location, which may itself include a particular physical configuration (e.g., a particular room shape, particular furniture in the room, particular light sources located within the room, etc.) and other environmental factors such as time of day, ambient light, and the like, that may vary between locations. Thus, when a playback system in a given location attempts to output the desired light settings, the output may differ from the desired light settings, which may in turn differ from output of another play system in a different location. This may cause variations in the light settings across different playback systems, even though each system may receive the same desired light settings.

According to the present disclosure, a playback system may monitor the light settings of the location which the playback of content occurs. The system may include at least one light meter, which may measure luminance experienced by the location over a period of time. The system may determine minimum and maximum luminance values over the period of time. When the playback system receives content and desired luminance output for the content (or section of the content), the playback system may adjust the desired luminance output according to the measured luminance of the location. The playback system may thus normalize the luminance output for content playback, which may provide for a more consistent luminance output across various locations and playback systems.

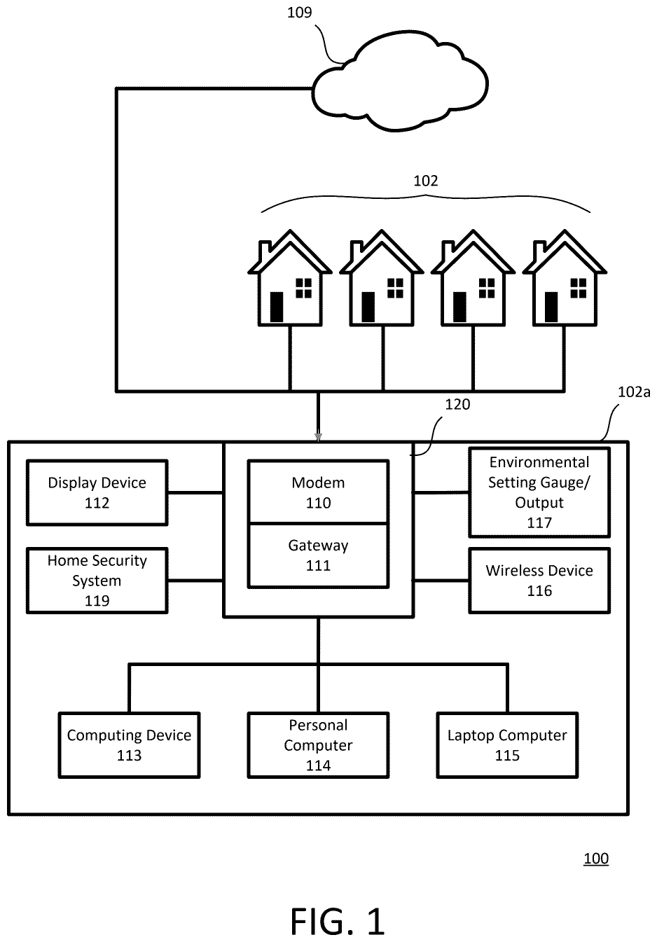

FIG. 1 shows an example communication network 100 on which many of the various features described herein may be implemented. Network 100 may be any type of information distribution network, such as satellite, telephone, cellular, wireless, etc. One example may be an optical fiber network, a coaxial cable network, or a hybrid fiber/coax distribution network. Such networks 100 may use a series of interconnected communication links (e.g., coaxial cables, optical fibers, wireless, etc.) to connect multiple premises 102 (e.g., businesses, homes, consumer dwellings, etc.) to an external network 109. The external network 109 may transmit downstream information signals via the links, and each premises 102 may have a receiver used to receive and process those signals.

The links may include components not shown, such as splitters, filters, amplifiers, etc. to help convey the signal clearly. Portions of the links may also be implemented with fiber-optic cable, while other portions may be implemented with coaxial cable, other lines, or wireless communication paths.

The external network 109 may be configured to place data on one or more downstream frequencies to be received by modems at the various premises 102, and to receive upstream communications from those modems on one or more upstream frequencies. The network 109 may include, for example, networks of Internet devices, telephone networks, cellular telephone networks, fiber optic networks, local wireless networks (e.g., WiMAX), satellite networks, and any other desired network.

In some cases, the external network 109 may send content to various premises 102. The content may include data configured for playback by a device of a premises, such as by playback device 113. The content may include video data, audio data, subtitle data, and the like. For example, the playback device 113 may be configured to request content from a content delivery network (CDN), which may be a part of, or is, the external network 109. The CDN may provide in response a manifest indicative of storage locations of segments of the content, and the playback device 113 may access or request access to the storage location in order to play back the content.

The external network 109 may be configured to provide playback instructions to the various premises. For example, the external network 109 may provide content, and associated playback instructions, to the premises 102. The playback instructions may include instructions for environmental settings for the premises 102 during playback. For example, the playback instructions may include a luminance setting for the premises 102 during playback of the content. The luminance setting may include a total luminance value (e.g., candela per square meter), a luminance composition (e.g., a light wavelength or combination of wavelengths), and the like. In some cases, the playback instructions may include environmental settings for particular devices of the premises 102. For example, the environmental settings may include a luminance value for output by a device designated as a back light, which may be positioned across a room from the playback device 113. In some cases, the playback instructions may also include a control range of values, such as a control minimum and a control maximum. The control range of values may correspond to Likewise, the playback instructions may include a plurality of environmental settings, where the environmental settings are designated for output by an individual device of the premises 102, or a subgroup of devices of the premises 102. Further, in some cases the environmental settings may include audio settings, noise floor data, sound direction data, temperature data, and the like.

An example premises 102a, such as a home, may include an interface 120 for creating a personal network at the premises 102a. The interface 120 may include any communication circuitry needed to allow a device to communicate on one or more links with other devices in the network. For example, the interface 120 may include a modem 110, which may include transmitters and receivers used to communicate on the links and with the external network 109 The modem 110 may be, for example, a coaxial cable modem (for coaxial cable lines), a fiber interface node (for fiber optic lines), twisted-pair telephone modem, cellular telephone transceiver, satellite transceiver, local wi-fi router or access point, or any other desired modem device. Also, although only one modem is shown in FIG. 1, a plurality of modems operating in parallel may be implemented within the interface 120. Further, the interface 120 may include a gateway interface device 111. The modem 110 may be connected to, or be a part of, the gateway interface device 111. The gateway interface device 111 may be one or more computing devices that communicate with the modem(s) 110 to allow one or more other devices in the premises 102a, to communicate with the network 109. The gateway 111 may be a set-top box (STB), digital video recorder (DVR), computer server, etc. The gateway 111 may also include (not shown) local network interfaces to provide communication signals to requesting entities/devices in the premises 102a, such as display devices 112 (e.g., televisions), computing device 113, personal computers 114, laptop computers 115, wireless devices 116 (e.g., wireless routers, wireless laptops, notebooks, tablets and netbooks, cordless phones (e.g., Digital Enhanced Cordless Telephone—DECT phones), mobile phones, mobile televisions, personal digital assistants (PDA) , etc.), environmental setting devices 117, security system devices 119, and any other desired devices. Examples of the local network interfaces include Multimedia Over Coax Alliance (MoCA) interfaces, Ethernet interfaces, universal serial bus (USB) interfaces, wireless interfaces (e.g., IEEE 802.11, IEEE 802.15), analog twisted pair interfaces, Bluetooth interfaces, and others.

The premises 102a may also include a computing device 113. The computing device 113 may be a playback device The computing device 113 may comprise a decoder, a buffer, a video player, and a digital video recorder (DVR). The computing device 113 may be communicatively connected to a display. The display may be a separate and discrete component from the computing device 113, such as a television display connected to a set-top box (e.g., display device 112). The display may be integrated with the computing device 113. The decoder, the video player, the buffer, the DVR, and the display may be realized in a single device, such as a laptop or mobile device. The decoder may decompress/decode encoded video data. The encoded video data may be received from an encoder/transcoder, a content packager, a content delivery network, etc., which may be provided, or be a part of external network 109.

The premises 102a may also include one or more environmental setting devices 117. The environmental setting devices 117 may be computing devices or premises devices. The environmental setting devices 117 may be IoT devices. The environmental setting devices 117 may be computing devices configured to communicate with other devices of the premises 102a, such as other environmental setting devices 117, gateway 111, computing device 113, and the like. The environmental setting devices 117 may include one or more sensors capable of collecting environmental setting data of the premises 102a, or a portion of the premises 102a (e.g., a room of the premises 102a). For example, an environmental setting device 117 may collect or measure light data (e.g., luminance), sound data, temperature data, and the like The environmental setting device may include a photometer, a noise meter, and the like. Additionally or alternatively, the environmental setting device 117 may output environmental settings for the premises 102a. The environmental setting device 117 may include an output component. The output component may include a speaker, a light, a heater, a cooler, and the like.

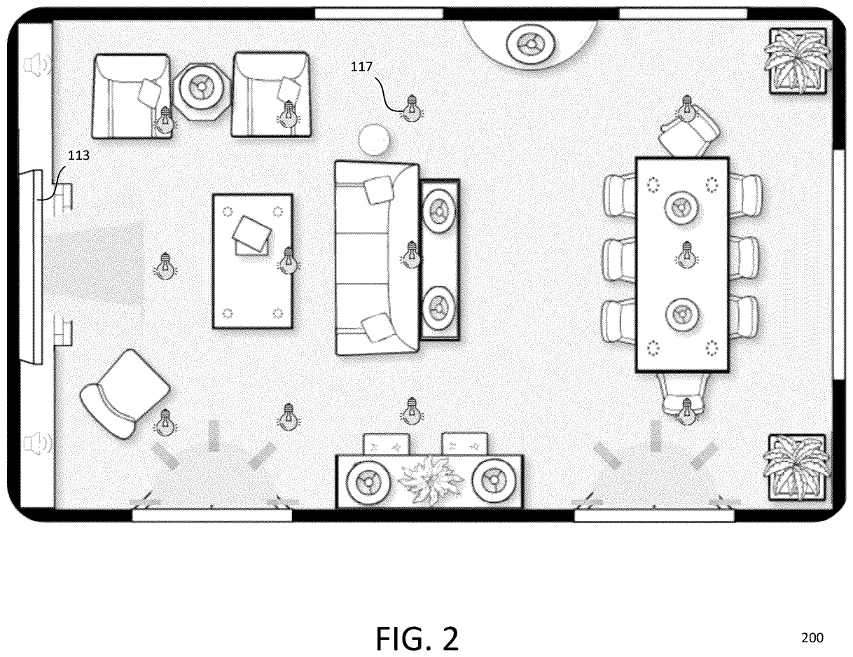

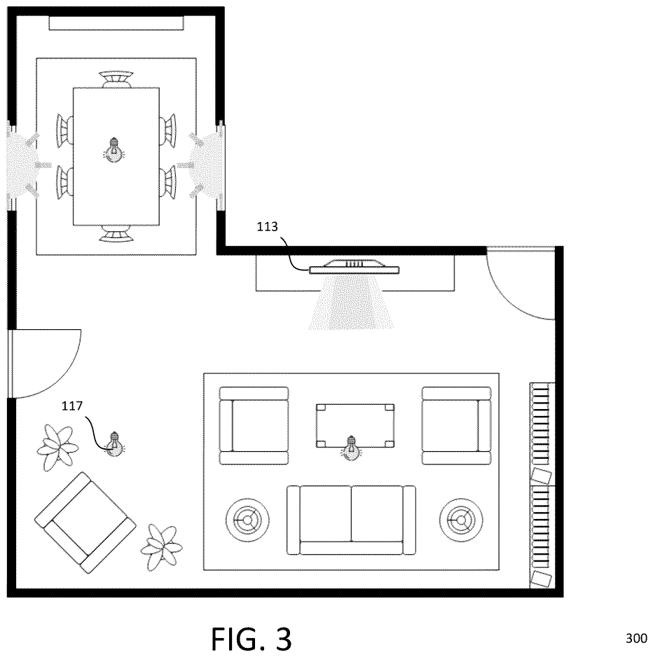

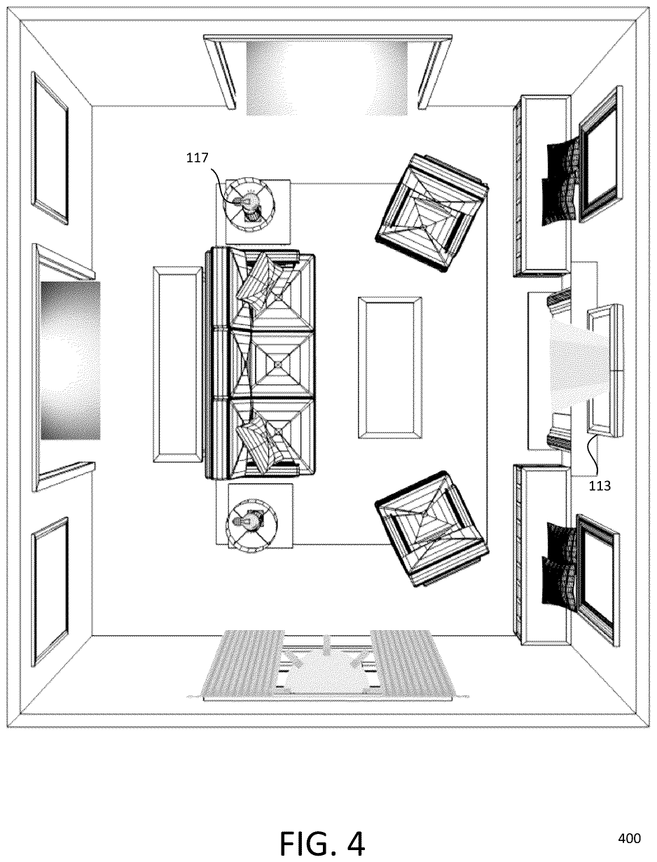

FIG. 2 shows an example content playback environment 200 according to the present disclosure. The environment 200 may include a computing device 113, which may be a playback device. The environment 200 may also include one or more environmental setting devices 117, one or more environmental output sources 205, or both. The environmental output sources 205 may be natural sources of an environmental setting, such as light (e.g., a window), noise (e.g., a kitchen appliance), temperature (e.g., a heating vent), and the like. Based on the configuration of the environment 200, such as the dimensions of the room, the layout of the room, the number and location of environmental output sources 205, number and location of environmental setting devices 117, and the like, may result in environmental settings, during playback of a content, that is unique to the environment 200. For example, FIGS. 3 and 4 show respective environments, each including respective computing devices 113, environmental output sources 205, and environmental setting devices 117. A given content may be played in each respective environment, 200, 300, and 400. However, due to the unique characteristics for each environment, environmental settings experienced within each environment may differ from one another. Thus, even when the content is associated with environmental setting instructions, which may instruct the environmental setting devices 117 to output an environmental setting parameter, the overall environmental setting a respective environment experiences may differ compared to other playback environments.

According to the disclosure described herein, a computing device of a premises (e.g., premises 102a) may receive instructions for outputting an environmental setting. The computing device may be a gateway of the premises, such as gateway 111. The computing device may be computing device 113 (e.g., a playback device). The instructions may correspond to a content, or a portion of content. For example, the instructions may be sent with a content. The instructions may be sent separate from the content, and may include an indication of the content, for example, a content identifier, to which the instructions correspond to. The instructions may also include an indication of a section or portion of the content which the instructions correspond to. For example, the instructions may correspond to a given chapter, scene, time period, and the like, of the content.

The instructions may include instructions for output of an environmental setting during playback of the corresponding content. The environmental setting may include a light setting, such as a luminance setting, a light shade setting (e.g., chrominance values), and the like. The environmental setting may include a noise setting, such as background noise setting, white noise background, and the like. The environmental setting may include a temperature level. The instructions may include environmental setting values, or information indicative of environmental setting values, for output during the content playback. For example, the instructions may include luminance values, chrominance values, noise levels (e.g., in dB) , temperature values (e.g., in degrees Fahrenheit or Celsius), and the like.

The instructions may include a range of values for the environmental setting. For example, the instructions may include at least a first environmental setting value and a second environmental setting value. In some cases, the first and second values may correspond to minimum and maximum values of the environmental setting. In some cases, the range of values for the environmental setting may include more than two (e.g., a median or average value, a percentile value, etc.).

The devices of the premises (e.g., premises 102a), may monitor, measure, record, etc. environmental setting values for the premises. For example, the premises may include at least one environmental setting gauge 117. The environmental setting gauge may detect environmental setting values for the premises over a period of time. For example, the environmental setting gauge may collect luminance data for the premises over 24 hours. The period of time may be predefined (e.g., 24 hours), and the sampling rate may be predefined (e.g., every 30 minutes). The environmental setting gauge may be in communication with other devices of the premises (e.g., the gateway, the playback device, etc.), and may send some or all of the collected environmental setting data to other device(s) of the premises. In some cases, more than one environmental setting gauges of the premises may collect environmental setting data, and each gauge may send the respective data to another device of the premises (e.g., the gateway, the playback device, etc.).

The receiving device of the premises (e.g., the gateway or playback device) may determine a maximum and minimum value of the environmental setting data received from the environmental setting gauge(s). In some cases, the minimum and maximum value may be determined across all the environmental gauge data received. In some cases, the receiving device may instruct the environmental setting gauge to initiate collecting of the environmental setting data. In some cases, the gateway or playback device of the premises may store positional data of the environmental gauge in relation to the respective gateway or playback device (e.g., a left speaker, a light gauge in a back section of a room, etc.), which may be used to select minimum and maximum environmental setting data for the premises.

The receiving device may determine modified environmental setting values for the content based on the collected environmental setting data for the premises. For example, the receiving device may adjust the environmental setting values corresponding to the content based on the collected environmental setting data. The environmental setting values may be adjusted according to a normalization or scaling calculation. For example, the environmental setting values may be adjusted according to: y=(x−x_min)*(y_max−y_min)/(x_max−x_min))+y_min, where y may be the adjusted or updated environmental setting value, x may be the received or control value for the environmental setting, x_min may be a minimum control value for the environmental setting, x_max may be a maximum control value for the environmental setting, y_min may be a minimum value for the environmental setting measured at the premises, and y_max may be a maximum value for the environmental setting measured at the premises.

The receiving device (e.g., the gateway or playback device) may send the adjusted environmental setting value to one or more output devices of the premises. For example, the receiving device may send the adjusted environmental setting value to another premises device, such as a device capable of outputting the environmental setting value (e.g., an environmental setting output device 117). The receiving device may also provide instructions to the output device corresponding to a time to output the adjusted environmental setting value (e.g., in 5 second, at a certain time, etc.). In some cases, the receiving device may provide an adjusted environmental setting value specific to the respective output device. For example, the receiving device may determine an adjusted environmental setting value for one or more output devices, and may send these values to the respective output devices for output during content playback.

As an example, an environment A (e.g., environment 200) and an environment B (environment 300) may receive instructions for outputting an environmental setting (e.g., luminance) during playback of a content (e.g., the same content). The environments A and B may each receive instructions indicative of a control range, such as a control minimum and a control maximum, and a control output value. For example, the environments may receive a control minimum value of 0 (e.g., lumens), and control maximum value of 100, and a first control output value of 30. The environment A may monitor, capture, or detect luminance values of the respective environment for a predefined period of time. For example, the luminance values of environment A may include a minimum value and a maximum value, which may be 5 and 90 respectively. Likewise, environment A may monitor, capture, or detect luminance value of the respective environment for a predefined period of time. For example, the luminance values of environment B may include a minimum value and a maximum value, which may be 10 and 70, respectively.

Based on the control values, and the detected values, the system of the respective environment may generate adjusted environmental setting values for playback of the content. For example, using the equation y=(x−x_min)*(y_max−y_min)/(x_max−x_min)+y_min as discussed above, the adjusted luminance value for playback in environment A may be 29.89. Similarly, the adjusted luminance value for playback in environment B may be 47.07.

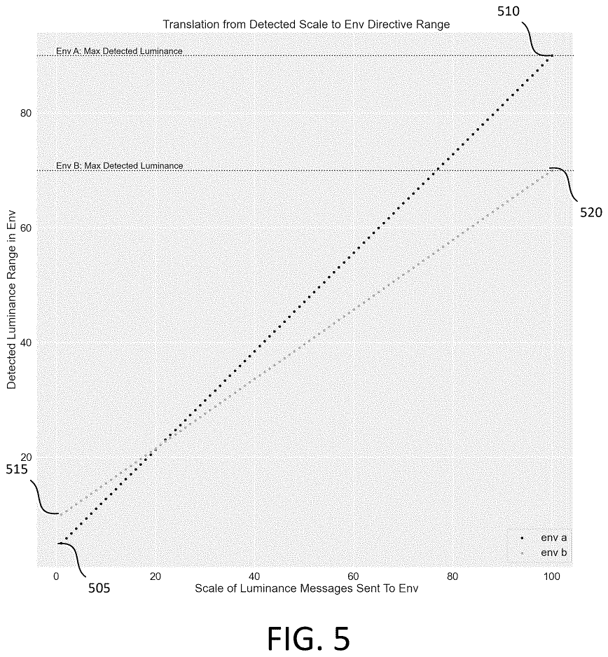

The system in environments A and B may receive a second control value, such as 50, which may correspond to another section of the content, or may correspond to a second content. Using the above equation, adjusted luminance value for playback in environment A may be 27.57, and the adjusted luminance value for playback in environment B may be 39.69. These adjusted values may facilitate a normalization or scaling of the respective control values according to the unique layout and characteristics of the playback environment. FIG. 5 shows example environmental parameters for environment A (e.g., min value 505 and max value 510) and environment B (min value 515 and max value 520).

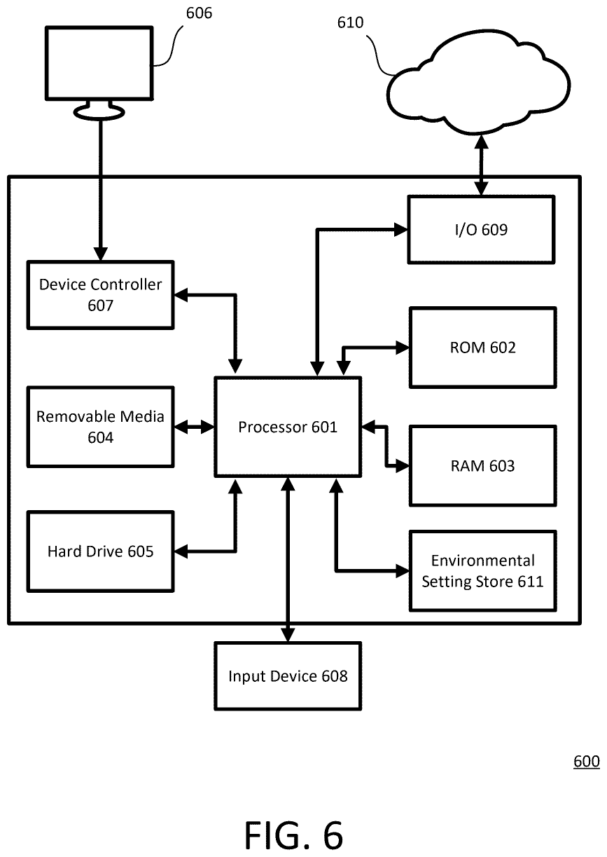

FIG. 6 shows general hardware elements that may be used to implement any of the various systems or computing devices discussed herein. The computing device 600 may include one or more processors 601, which may execute instructions of a computer program to perform any of the features described herein. The instructions may be stored in any type of computer-readable medium or memory, to configure the operation of the processor 601. For example, instructions may be stored in a read-only memory (ROM) 602, random access memory (RAM) 603, removable media 604, such as a Universal Serial Bus (USB) drive, compact disk (CD) or digital versatile disk (DVD), floppy disk drive, or any other desired storage medium. Instructions may also be stored in an attached (or internal) hard drive 605. The computing device 600 may include one or more output devices, such as a display 606 (e.g., an external television), and may include one or more output device controllers 607, such as a video processor. There may also be one or more user input devices 608, such as a remote control, keyboard, mouse, touch screen, microphone, camera input for user gestures, etc. The computing device 600 may also include one or more network interfaces, such as a network input/output (I/O) circuit 609 (e.g., a network card) to communicate with an external network 610 (e.g., the personal network of premises 102a). The network input/output circuit 609 may be a wired interface, wireless interface, or a combination of the two. In some examples, the network input/output circuit 609 may include a modem (e.g., a cable modem), and the external network 610 may the external network 109, an in-home network, a provider's wireless, coaxial, fiber, or hybrid fiber/coaxial distribution system (e.g., a DOCSIS network), or any other desired network. Additionally, in some examples the device may be configured to implement one or more aspects discussed herein. For example, the device may include an environmental setting store 611, which may be configured to receive, store, and send information regarding environmental setting data. For example, the environmental setting store 611 may store control environmental setting data, such as control setting range(s), control setting value(s), and the like. The environmental setting store 611 ay also store monitored environmental setting data for a corresponding premises, and adjusted environmental setting data. The environmental setting store 611 may utilize other components of the device, such as hard drive 605, removable media 604, and/or RAM 603.

The FIG. 6 example is a hardware configuration, although the shown components may be wholly or partially implemented as software as well. Modifications may be made to add, remove, combine, divide, etc. components of the computing device 600 as desired. Additionally, the components shown may be implemented using basic computing devices and components, and the same components (e.g., processor 601, ROM storage 602, display 606, etc.) may be used to implement any of the other computing devices and components described herein. For example, the various components herein may be implemented using computing devices having components such as a processor executing computer-executable instructions stored on a computer-readable medium, as shown in FIG. 6. Some or all of the entities described herein may be software based, and may co-exist in a common physical platform.

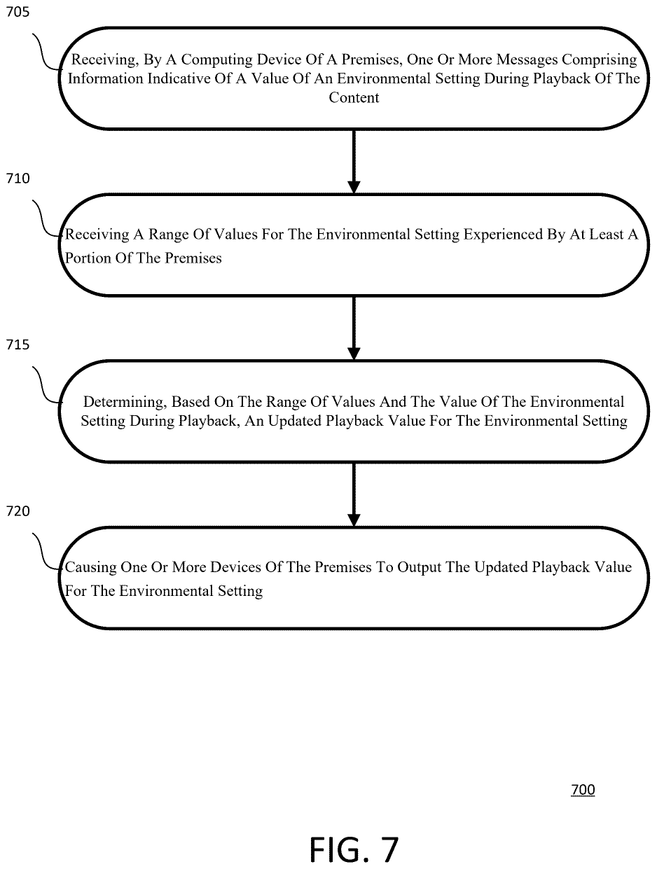

FIG. 7 shows an example method 700 for consistent playback environments as discussed herein. The method of FIG. 7 may be implemented in one or more computing devices, such as computing device 600 of FIG. 6. In some cases, the method of FIG. 7 may be implemented by a processor of the one or more computing devices, and executable instructions according to the method may be stored on a memory of the one or more computing devices. The one or more computing devices may be part of a network, such as network 100 or of a personal network of a premises 102 of FIG. 1. The process may be implemented in a network environment having multiple users and respective user devices such as set-top boxes, smart televisions, tablet computers, smartphones, and/or any other suitable access device (e.g., display device 112, gateway 111, personal computer 114, wireless device 116, etc.), or any other desired computing devices. The shown method may in some cases be performed by one or more computing devices in the network. Although the steps of the method may be described with regard to a computing device, it should be understood that the various steps of the method may be handled by different computing devices without departing from the aspects and features described herein.

At Step 705, one or more messages comprising information indicative of a value of an environmental setting during playback of the content. The one or more messages may be received by a computing device of a premises. The computing device may be a gateway of the premises. In some cases, the computing device may be a playback device of the premises. The one or more messages may include control values for an environmental setting of the premises. For example, the one or more messages may include a control value of an environmental setting corresponding to a portion of the content, such as one or more content segments. The one or more messages may include a control range, such as a control minimum value and a control maximum value. In some cases, the one or more messages may also include the content for playback. Alternatively, the content may be sent separately from the one or more messages. The environmental setting may be a light setting, such as a luminance value or a chrominance value.

At Step 710, a range of values for the environmental setting experienced by at least a portion of the premises may be received. The range of values for the environmental setting may be monitored, detected, sensed, etc., by one or more computing devices of the premises. The range of values may be over a predefined period of time (e.g., 24 hours). The range of values may include a minimum value and a maximum value. In some cases, the range of values may be collected by a plurality of computing devices of the premises.

At Step 715, an updated playback value for the environmental setting may be determined. The updated playback value may be determined based on the range of values and the value of the environmental setting. The updated playback value may also be based on the range of values received in the one or more messages. The updated playback value may be determined based on y=(x−x_min)*(y_max−y_min)/(x_max−x_min)+y_min, where y may be the adjusted or updated environmental setting value, x may be the received or control value for the environmental setting, x_min may be a minimum control value for the environmental setting, x_max may be a maximum control value for the environmental setting, y_min may be a minimum value for the environmental setting measured at the premises, and y_max may be a maximum value for the environmental setting measured at the premises.

At Step 720, one or more devices of the premises may be caused to output the updated playback value of the environmental setting. A computing device may send the updated playback value to the one or more devices of the premises. The sending may include a set of messages instructing the one or more devices to output the updated playback value at a particular period of time, content segment, chapter of the content, and the like. The one or more devices of the premises may be IoT devices, and the sending the set of messages may occur over one or IoT communication links, or over an IoT communication network.

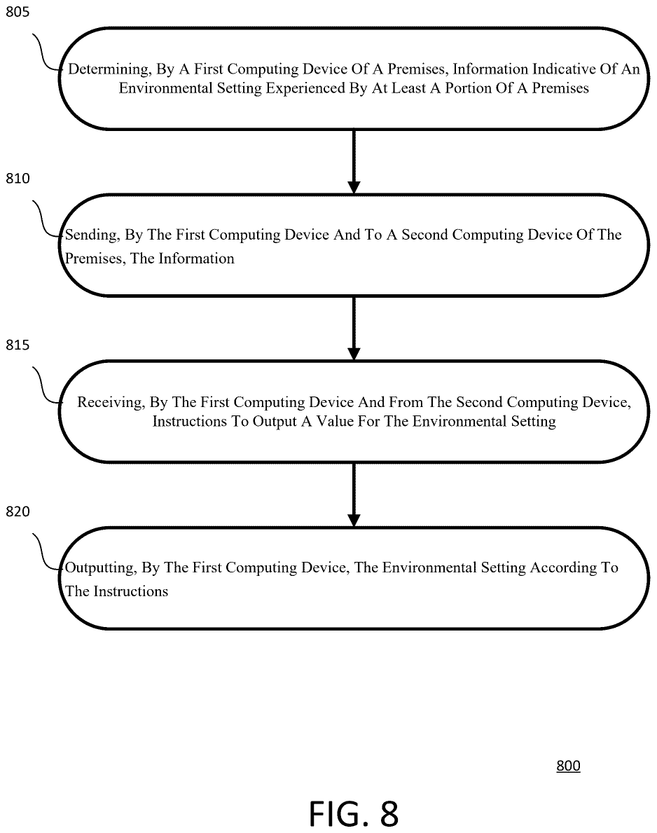

FIG. 8 shows an example method 800 for consistent playback environments as discussed herein. The method of FIG. 8 may be implemented in one or more computing devices, such as computing device 600 of FIG. 6. In some cases, the method of FIG. 8 may be implemented by a processor of the one or more computing devices, and executable instructions according to the method may be stored on a memory of the one or more computing devices. The one or more computing devices may be part of a network, such as network 100 or of a personal network of a premises 102 of FIG. 1. The process may be implemented in a network environment having multiple users and respective user devices such as set-top boxes, smart televisions, tablet computers, smartphones, and/or any other suitable access device (e.g., display device 112, gateway 111, personal computer 114, wireless device 116, etc.), or any other desired computing devices. The shown method may in some cases be performed by one or more computing devices in the network. Although the steps of the method may be described with regard to a computing device, it should be understood that the various steps of the method may be handled by different computing devices without departing from the aspects and features described herein.

At Step 805, information indicative of an environmental setting experienced by at least a portion of a premises may be determined. The determination may be made by a first computing device of a premises. The first computing device may be an IoT device. The first computing device may monitor, detect, capture, etc., environmental setting values experienced by the premises. In some cases, the environmental setting may be a light setting, such as luminance or chrominance settings. The first computing device may include a light collection component, such as a photometer. The information may include one or more environmental setting values experienced by the premises. The one or more environmental setting values may be collected, measured, etc., over a predefined period of time (e.g., 24 hours). The one or more environmental setting values may include a range of values. For example, the one or more environmental setting values may include a minimum value, a maximum value, or both.

At Step 810, the first computing device may send the information to a second computing device. The second computing device may be a gateway of the premises, or a playback device of the premises. The information may be sent over one or more IoT communication links, or over an IoT network.

At Step 815, the first computing device may receive instructions to output a value for the environmental setting. The instructions may be received from the second computing device. The value of the environmental setting may be based on the information indicative of the environmental setting experienced by at least the portion of the premises. The value of the environmental setting may be an adjusted or modified environmental setting value. The environmental setting value may further be based on control environmental setting values received by the second computing device and external to the premises (e.g., from an external network).

At Step 820, the second computing device may output the environmental setting value according to the instructions. For example, in cases where the environmental setting is a light setting, the second computing device may be a smart light or a smart light bulb. The instruction may further indicate a timing for the output to occur. For example, the instructions may further provide information related to a playing back of content segment or segments the output corresponds to. In some cases, the instructions may provide a time or time period which the output is to occur.

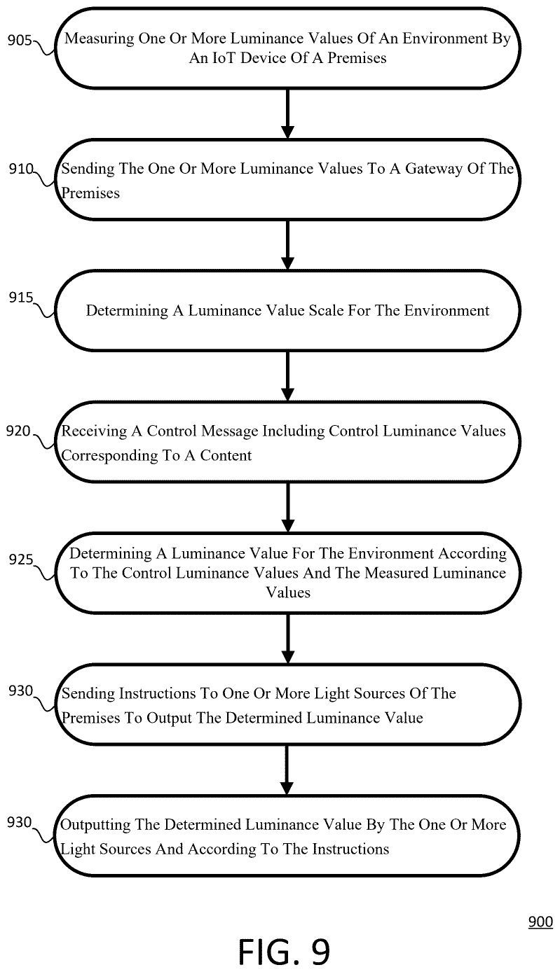

FIG. 9 shows an example method 900 for consistent playback environments as discussed herein. The method of FIG. 9 may be implemented in one or more computing devices, such as computing device 600 of FIG. 6. In some cases, the method of FIG. 9 may be implemented by a processor of the one or more computing devices, and executable instructions according to the method may be stored on a memory of the one or more computing devices. The one or more computing devices may be part of a network, such as network 100 or of a personal network of a premises 102 of FIG. 1. The process may be implemented in a network environment having multiple users and respective user devices such as set-top boxes, smart televisions, tablet computers, smartphones, and/or any other suitable access device (e.g., display device 112, gateway 111, personal computer 114, wireless device 116, etc.), or any other desired computing devices. The shown method may in some cases be performed by one or more computing devices in the network. Although the steps of the method may be described with regard to a computing device, it should be understood that the various steps of the method may be handled by different computing devices without departing from the aspects and features described herein.

At Step 905, a IoT device may measure one or more luminance values of an environment. The IoT device, for example, may be a smart light or light sensor. The IoT device may be located in a premises, such as a room in a house, which may be the environment of the IoT device. The IoT device may be connected to a network, such as a personal network. The personal network may include a number of other computing devices in the premises, such as a playback device, a gateway, light sources, etc. The IoT device may include a light sensor for measuring the luminance value. For example, the lot device may include a light meter.

In some cases, the IoT device may measure luminance values for the environment over a period of time. For example, the IoT device may measure luminance value according to a sensing cycle, such as every 20 minutes, every 2 hours, etc. The period of time may be a predefined period of time, such as a day, two days, a week, etc.

At Step 910, the IoT device may send the measured luminance values to a gateway of the premises. The IoT device may be in wireless communication with the gateway of the personal network. In some cases, the IoT device may send a portion of the measured luminance values, such as minimum and maximum luminance values measured.

At Step 915, the gateway may determine a range or scale of the luminance values for the environment. In some cases, the gateway may be in wireless communication with other IoT devices in the room of the premises, and may receive additional luminance values from one or more of these other devices. The gateway may determine total maximum and minimum luminance values for the environment based on the values received from the one or more IoT devices. The gateway may generate a linear scale or table for the environment according to the received luminance values.

At Step 920, the gateway may receive a control message corresponding to a content. The control message may include a control luminance information for a portion of the content, such as a content segment (e.g., showing a scene of a movie, etc.). The control luminance information may include a control range for luminance values, and a control luminance value for the portion of the content (e.g., a value of 30). The control range may be represented by a minimum and maximum control luminance value (e.g., 0 and 100, respectively).

At Step 925, the gateway may determine a luminance value for the environment based on the control luminance information and the measured luminance values for the environment. The gateway may normalize or convert the control luminance information to the luminance values measured for the environment. For example, the control luminance value received for the portion of the content (e.g., 30) may be converted to a luminance value for the particular environment of the IoT device and gateway (e.g., 47.07). For example, the determining may be according to: y=(x−x_min)*(y_max−y_min)/(x_max−x_min)+y_min, where y is the converted luminance value for the particular environment, x_min and x_max are the control luminance minimum and maximum values received in the control luminance information (e.g., 0 and 100, respectively, etc.), x is the control luminance value for the portion of the content (e.g., 30), and y_min and y_max are the measured maximum and minimum values for the environment (e.g., 10 and 70, respectively, etc.).

At Step 930, the gateway may send instructions to one or more light sources to operate according to the converted luminance value. For example, one or more light sources may be a part of the personal network, and may be in wireless communication with the gateway. The gateway may send messages to one or more light sources indicative of a luminance output for the light source. The luminance output may correspond to a playback time of the portion of the content, such that the respective light source may output light having a luminance value according to the message from the gateway and during payback of the content portion. In some cases, the luminance output can be a portion of the luminance output determined for the portion of content, as the environment (e.g., room) may include multiple light sources, with each receiving instructions for outputting a luminance value for playback of the content portion. At Step 935, one or more of the light sources may output the determined luminance value for the environment according to the messages received from the gateway.

Components are described herein that may be used to perform the described methods and systems. When combinations, subsets, interactions, groups, etc., of these components are described, it is understood that while specific references to each of the various individual and collective combinations and permutations of these may not be explicitly described, each is specifically contemplated and described herein, for all methods and systems. This applies to all aspects of this application including, but not limited to, operations in described methods. Thus, if there are a variety of additional operations that may be performed it is understood that each of these additional operations may be performed with any specific embodiment or combination of embodiments of the described methods.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. M ore particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described herein with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described herein may be used independently of one another, or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto may be performed in other sequences that are appropriate. For example, described blocks or states may be performed in an order other than that specifically described, or multiple blocks or states may be combined in a single block or state. The example blocks or states may be performed in serial, in parallel, or in some other manner. Blocks or states may be added to or removed from the described example embodiments. The example systems and components described herein may be configured differently than described. For example, elements may be added to, removed from, or rearranged compared to the described example embodiments.

It will also be appreciated that various items are illustrated as being stored in memory or on storage while being used, and that these items or portions thereof may be transferred between memory and other storage devices for purposes of memory management and data integrity. Alternatively, in other embodiments, some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as determined data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present embodiments may be practiced with other computer system configurations.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its operations be performed in a specific order. Accordingly, where a method claim does not actually recite an order to be followed by its operations or it is not otherwise specifically stated in the claims or descriptions that the operations are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

It will be apparent to those skilled in the art that various modifications and variations may be made without departing from the scope or spirit of the present disclosure. Other embodiments will be apparent to those skilled in the art from consideration of the specification and practices described herein. It is intended that the specification and example figures be considered as exemplary only, with a true scope and spirit being indicated by the following claims.

1. A method, comprising:
receiving, by a computing device, a plurality of luminance values measured by one or more devices located at a premises;
receiving a control luminance value corresponding to a portion of a content;
determining, based on the plurality of measured luminance values and the control luminance value, one or more playback luminance values for playback of the portion of the content; and
causing one or more light sources at the premises to output light according to the one or more playback luminance values and during playback of the portion of the content.

2. The method of claim 1, wherein the plurality of measured luminance values comprises at least a minimum luminance value and a maximum luminance value.

3. The method of claim 1, wherein the control luminance value further comprises a control range of luminance values, and wherein the determining is further based on the control range.

4. The method of claim 3, wherein the control range comprises at least a control minimum luminance value and a control maximum luminance value.

5. The method of claim 1, wherein the determining the one or more playback luminance values further comprises calculating the one or more playback luminance values according to the equation:
y=((x−x_min)*(y_max−y_min)/(x_max−x_min))+y_min,
wherein y comprises a playback luminance value, x comprises the control luminance value, x_min comprises a control minimum luminance value, x_max comprises a control maximum luminance value, y_min comprises a minimum luminance value of the plurality of measured luminance values, and y_max comprises a maximum luminance value of the plurality of measured luminance values.

6. The method of claim 1, wherein portion of the content comprises one or more content segments.

7. The method of claim 1, wherein the one or more devices, the one or more light sources, or both, comprise one or more Internet of Things (IoT) devices.

8. The method of claim 1, wherein the plurality of measured luminance values are measured over a predefined time period.

9. An apparatus comprising:
one or more processors;
memory; and
a set of instructions stored in the memory that, when executed by the one or more processors, cause:
receiving, by the apparatus of a premises, a plurality of luminance values measured by one or more devices located at the premises;
receiving a control luminance value corresponding to a portion of a content;
determining, based on the plurality of measured luminance values and the control luminance value, one or more playback luminance values for playback of the portion of the content; and
causing one or more light sources of the premises to output light according to the one or more playback luminance values and during playback of the portion of the content.

10. The apparatus of claim 9, wherein the plurality of measured luminance values comprises at least a minimum luminance value and a maximum luminance value.

11. The apparatus of claim 9, wherein the control luminance value further comprises a control range of luminance values, and wherein the determining is further based on the control range.

12. The apparatus of claim 11, wherein the control range comprises at least a control minimum luminance value and a control maximum luminance value.

13. The apparatus of claim 9, wherein the determining the one or more playback luminance values further comprises calculating the playback luminance value according to the equation:
y=((x−x_min)*(y_max−y_min)/(x_max−x_min))+y_min,
wherein y comprises a playback luminance value, x comprises the control luminance value, x_min comprises a control minimum luminance value, x_max comprises a control maximum luminance value, y_min comprises a minimum luminance value of the plurality of measured luminance values, and y_max comprises a maximum luminance value of the plurality of measured luminance values.

14. The apparatus of claim 9, wherein portion of the content comprises one or more content segments.

15. The apparatus of claim 9, wherein the one or more devices, the one or more light sources, or both, comprise one or more Internet of Things (IoT) devices.

16. The apparatus of claim 9, wherein the plurality of measured luminance values are measured over a predefined time period.

17. A non-transitory, computer-readable medium comprising a set of computer-executable instructions that, when executed by one or more processors, cause:
receiving, by a computing device of a premises, a plurality of luminance values measured by one or more devices located at the premises;
receiving a control luminance value corresponding to a portion of a content;
determining, based on the plurality of measured luminance values and the control luminance value, one or more playback luminance values for playback of the portion of the content; and
causing one or more light sources of the premises to output light according to the one or more playback luminance value and during playback of the portion of the content.

18. The non-transitory, computer-readable medium of claim 17, wherein the plurality of measured luminance values comprises at least a minimum luminance value and a maximum luminance value.

19. The non-transitory, computer-readable medium of claim 17, wherein the control luminance value further comprises a control range of luminance values, and wherein the determining is further based on the control range.

20. The non-transitory, computer-readable medium of claim 19, wherein the control range comprises at least a control minimum luminance value and a control maximum luminance value.
